(19) United States
(12) Patent Application Publication
(10) Pub. No.: US 2025/0050498 A1
(43) Pub. Date: Feb. 13, 2025

(54) AUTOMATIC MULTI-PROCESS SURFACE OVERTURNING, POSITIONING SURFACE ROTATING AND GRIPPER GRIPPING MECHANISMS AND COMBINED METHOD THEREOF

(71) Applicant: SHENZHEN FSJ INTELLIGENT TECHNICAL CO., LTD., SHENZHEN (CN)

(72) Inventor: XUEHONG LIU, SHENZHEN (CN)

(21) Appl. No.: 18/931,004

(22) Filed: Oct. 29, 2024

Related U.S. Application Data
(63) Continuation of application No. PCT/CN2023/088153, filed on Apr. 13, 2023.

(30) Foreign Application Priority Data
Apr. 29, 2022 (CN) 202210465815.1

(51) Int. Cl. B25J 9/16; B25J 9/10; B25J 11/00; B25J 15/00

(52) U.S. Cl. CPC B25J 9/1612; B25J 9/10; B25J 9/1664; B25J 11/005; B25J 15/0028

(57) ABSTRACT

Automatic multi-process surface overturning, positioning surface rotating and gripper gripping mechanisms and a combined method thereof are provided, where the automatic multi-process surface overturning, positioning surface rotating and gripper gripping mechanisms include a first fixing support (2.8), where the first fixing support (2.8) is configured to install the automatic multi-process surface overturning mechanism, a positioning surface rotating mechanism and a first material tray (2.11), the gripper gripping mechanism is installed on an external movement support (1.9).

### CROSS REFERENCE TO RELATED APPLICATION

This application is a continuation of International Patent Application No. PCT/CN2023/088153 with a filing date of Apr. 13, 2023, designating the United States, now pending, further claim priority benefit of Chinese patent application CN202210465815.1, filed Apr. 29, 2022. The content of the aforementioned applications, including any intervening amendments thereto, are incorporated herein by reference.

### TECHNICAL FIELD

The present invention relates to the technical field of machining and assembly, and more specifically, relates to automatic multi-process surface overturning, positioning surface rotating and gripper gripping mechanisms and a combined method thereof.

### TECHNICAL BACKGROUND

A conventional automatic overturning mechanism consists of a group of a rotating mechanism, a gripper gripping mechanism at an end of the rotating mechanism, and a workpiece tray. A working method is that an external mechanism grips a workpiece to a workpiece clamping point at the workpiece tray (or another clamping mechanism), the rotating mechanism grips the workpiece through the gripper at the end and rotates to a to-be-machined surface, and after the workpiece is put back to the workpiece tray, the external mechanism can remove the workpiece.

The conventional machined surface overturning mechanism generally has only a group of rotating mechanisms, uses an air cylinder to drive the rotating mechanisms, and can only complete overturning of one machined surface or one assembled surface, but cannot complete overturning of all machined surfaces or assembled surfaces for multi-process products independently, that is, each step of the process can be completed only with manual assistance to turn over the workpiece.

### SUMMARY

### 1. To-Be-Resolved Technical Problems

In view of the problems existing in the prior art, an objective of the present invention is to provide automatic multi-process surface overturning, positioning surface rotating and gripper gripping mechanisms and a combined method thereof. The present invention can be applied to a CNC machining center or other computer numerical control devices, and material loading or unloading equipment of an assembly device. The automatic multi-process surface overturning mechanism and the positioning surface rotating mechanism can complete automatic overturning of the process surfaces and automatic rotation of the positioning surface with automatic assistance of the gripper gripping mechanism in a workpiece process switching procedure without a need to manually overturn the workpiece, which significantly saves manpower and labor. The mechanisms can complete finished product production of multi-process products independently, and therefore, a problem of switching between machining processes and problems of workpiece stacking space and retention are reduced, and an uneven ratio of machines is improved; the mechanisms make it no longer difficult or expensive to operate the machines around the clock, which fully exerts capacities of the machines; and a limitation of personnel management and uncontrollable costs in the machining industry are eliminated.

### 2. Technical Solutions

To resolve the foregoing problems, the following technical solution is used in the present invention.

Automatic multi-process surface overturning, positioning surface rotating and gripper gripping mechanisms and a combined method thereof are provided and the automatic multi-process surface overturning, positioning surface rotating and gripper gripping mechanisms include a first fixing support, where the first fixing support is configured to install the automatic multi-process surface overturning mechanism, a positioning surface rotating mechanism and a first material tray, the gripper gripping mechanism is installed on an external movement support, the gripper gripping mechanism includes a first rotating mechanism, a power mechanism of the first rotating mechanism, a first gripper, a second gripper, a third gripper, a fourth gripper, a first telescopic mechanism, and a second telescopic mechanism, the first rotating mechanism is installed on the external movement support, and the first telescopic mechanism and the second telescopic mechanism are both installed on the first rotating mechanism. The present invention can be applied to a CNC machining center or other computer numerical control devices, and material loading or unloading equipment of an assembly device. The automatic multi-process surface overturning mechanism and the positioning surface rotating mechanism can complete automatic overturning of the process surfaces and automatic rotation of the positioning surface with automatic assistance of the gripper gripping mechanism in a workpiece process switching procedure without a need to manually overturn the workpiece, which significantly saves manpower and labor. The mechanisms can complete finished product production of multi-process products independently, and therefore, a problem of switching between machining processes and problems of workpiece stacking space and retention are reduced, and an uneven ratio of machines is improved; the mechanisms make it no longer difficult or expensive to operate the machines around the clock, which fully exerts capacities of the machines; and a limitation of personnel management and uncontrollable costs in the machining industry are eliminated.

Further, a first gripper gripping mechanism and a second gripper gripping mechanism are in one group, the first gripper gripping mechanism and the second gripper gripping mechanism respectively match the first gripper and the second gripper, the third gripper gripping mechanism and the fourth gripper gripping mechanism are in one group, and the third gripper gripping mechanism and the fourth gripper gripping mechanism respectively match the third gripper and the fourth gripper. The first gripper gripping mechanism and the second gripper gripping mechanism cooperate with the first gripper and the second gripper to grip and put the machined workpiece body, and a gripper gripping direction can be set as leftward, rightward, frontward or backward according to a machining requirement; and the third gripper gripping mechanism and the fourth gripper gripping mechanism cooperate with the third gripper and the fourth gripper to grip and put the machined workpiece body, a gripper gripping direction can be set as leftward, rightward, frontward or backward according to a machining requirement, and the first rotating mechanism can be rotated by 180°, to switch between four grippers such as the first gripper.

Further, the automatic multi-process surface overturning mechanism includes a third telescopic mechanism, a fourth telescopic mechanism, a second rotating mechanism, a third rotating mechanism, a fifth gripper, and a sixth gripper, the third telescopic mechanism is equipped with a power mechanism of the third telescopic mechanism, the fourth telescopic mechanism is equipped with a power mechanism of the fourth telescopic mechanism, the second rotating mechanism is equipped with a power mechanism of the second rotating mechanism, the third rotating mechanism is equipped with a power mechanism of the third rotating mechanism, the third telescopic mechanism and the fourth telescopic mechanism are both installed on the second fixing support, the second rotating mechanism is installed on the third telescopic mechanism, the third rotating mechanism is installed on the fourth telescopic mechanism, the fifth gripper is installed on the second rotating mechanism, and the sixth gripper is installed on the third rotating mechanism. The third telescopic mechanism drives the second rotating mechanism and the fifth gripper to perform linear movement along the x-axis, and the second rotating mechanism can drive the fifth gripper to rotate by any angle around the x-axis and drive overturning completion of the multi-process surface of the machined workpiece body; and the fourth telescopic mechanism drives the third rotating mechanism and the sixth gripper to perform linear movement along the y-axis, and the third rotating mechanism can drive the sixth gripper to rotate by any angle around the y-axis and drive overturning completion of the multi-process surface of the machined workpiece body.

Further, the positioning surface rotating mechanism includes a fifth telescopic mechanism, a fourth rotating mechanism and the first material tray, the fifth telescopic mechanism is equipped with a power mechanism of the fifth telescopic mechanism, the fourth rotating mechanism is equipped with the power mechanism of the fourth rotating mechanism, the fifth telescopic mechanism is installed on the second fixing support, the fourth rotating mechanism is installed on the fifth telescopic mechanism, and the first material tray is installed on the fourth rotating mechanism. The fifth telescopic mechanism drives the fourth rotating mechanism and the first material tray to perform linear movement along the z-axis, and the fourth rotating mechanism can drive the first material tray to rotate by any angle around the z-axis and drive overturning of multiple positioning surfaces of the machined workpiece body.

Further, the automatic multi-process surface overturning mechanism includes a third telescopic mechanism, a power mechanism of the third telescopic mechanism, a seventh telescopic mechanism, a power mechanism of the seventh telescopic mechanism, a second rotating mechanism, a power mechanism of the second rotating mechanism, the sixth rotating mechanism, the fifth gripper, and the sixth gripper; and the seventh telescopic mechanism is installed on the second fixing support, the sixth rotating mechanism is installed on the seventh telescopic mechanism, the sixth rotating mechanism is equipped with a power mechanism of the sixth rotating mechanism, and the sixth gripper is installed on the sixth rotating mechanism. The third telescopic mechanism can drive the second rotating mechanism to perform telescopic movement along the x-axis, the second rotating mechanism can drive the fifth gripper to perform rotational movement along the x-axis direction, to overturn the machined surface of the workpiece body, and the fifth gripper can grip and put the workpiece body; and the seventh telescopic mechanism can drive the sixth rotating mechanism to perform telescopic movement along the y-axis direction, the sixth rotating mechanism can drive the sixth gripper to perform rotational movement along the y-axis, to overturn the machined surface of the workpiece body, and the sixth gripper can grip and put the workpiece body.

Further, the positioning surface rotating mechanism includes the fourth telescopic mechanism, the power mechanism of the fourth telescopic mechanism, the fifth telescopic mechanism, the power mechanism of the fifth telescopic mechanism, a sixth telescopic mechanism, a power mechanism of the sixth telescopic mechanism, an eighth telescopic mechanism, a ninth telescopic mechanism and a tenth telescopic mechanism, and the positioning surface rotating mechanism includes the third rotating mechanism, the power mechanism of the third rotating mechanism, the fourth rotating mechanism, the power mechanism of the fourth rotating mechanism, the fifth rotating mechanism, the seventh rotating mechanism, an eighth rotating mechanism, a ninth rotating mechanism, a second material tray, a third material tray, a fourth material tray, a fifth material tray, a sixth material tray, and a seventh material tray. The fourth telescopic mechanism can drive the third rotating mechanism to perform telescopic movement along the z-axis direction, the third rotating mechanism can drive the second material tray to perform rotational movement along the z-axis, to rotate the positioning surface, and the second material tray can hold the workpiece body; the fifth telescopic mechanism can drive the fourth rotating mechanism to perform telescopic movement along the z-axis direction, the fourth rotating mechanism can drive the third material tray to perform rotational movement along the z-axis, to rotate the positioning surface, and the third material tray can hold the workpiece body; the sixth telescopic mechanism can drive the fifth rotating mechanism to perform telescopic movement along the z-axis direction, the fifth rotating mechanism can drive the fourth material tray to perform rotational movement along the z-axis, to rotate the positioning surface, and the fourth material tray can hold the workpiece body; the eighth telescopic mechanism can drive the seventh rotating mechanism to perform telescopic movement along the z-axis direction, the seven rotating mechanism can drive the fifth material tray to perform rotational movement along the z-axis, to rotate the positioning surface, and the fifth material tray can hold the workpiece body; the ninth telescopic mechanism can drive the eighth rotating mechanism to perform telescopic movement along the z-axis direction, the eighth rotating mechanism can drive the sixth material tray to perform rotational movement along the z-axis, to rotate the positioning surface, and the sixth material tray can hold the workpiece body; and the tenth telescopic mechanism can drive the ninth rotating mechanism to perform telescopic movement along the z-axis direction, the ninth rotating mechanism can drive the seventh material tray to perform rotational movement along the z-axis, to rotate the positioning surface, and the seventh material tray can hold the workpiece body.

Further, the eighth telescopic mechanism is equipped with the power mechanism of the eighth telescopic mechanism, the ninth telescopic mechanism is equipped with the power mechanism of the ninth telescopic mechanism, the tenth telescopic mechanism is equipped with the power mechanism of the tenth telescopic mechanism, the fifth rotating mechanism is equipped with the power mechanism of the fifth rotating mechanism, the seventh rotating mechanism is equipped with the power mechanism of the seventh rotating mechanism, the eighth rotating mechanism is equipped with the power mechanism of the eighth rotating mechanism, the ninth rotating mechanism is equipped with the power mechanism of the ninth rotating mechanism, and the sixth telescopic mechanism, the seventh telescopic mechanism, the eighth telescopic mechanism, the ninth telescopic mechanism and the tenth telescopic mechanism are all installed on the first fixing support. The power mechanism of the eighth telescopic mechanism, the power mechanism of the ninth telescopic mechanism and the power mechanism of the tenth telescopic mechanism are disposed, to provide power assistance for telescopic operation of the eighth telescopic mechanism, the ninth telescopic mechanism and the tenth telescopic mechanism. In addition, the power mechanism of the fifth rotating mechanism, the power mechanism of the seventh rotating mechanism, the power mechanism of the eighth rotating mechanism and the power mechanism of the ninth rotating mechanism provide power assistance for rotational operation of the fifth rotating mechanism, the seventh rotating mechanism, the eighth rotating mechanism and the ninth rotating mechanism.

Further, the fifth rotating mechanism is installed on the sixth telescopic mechanism, the seventh rotating mechanism is installed on the eighth telescopic mechanism, the eighth rotating mechanism is installed on the ninth telescopic mechanism, the ninth rotating mechanism is installed on the tenth telescopic mechanism, the second material tray is installed on the third rotating mechanism, the third material tray is installed on the fourth rotating mechanism, the fourth material tray is installed on the fifth rotating mechanism, and the fifth material tray is installed on the seventh rotating mechanism, the sixth material tray is installed on the eighth rotating mechanism, and the seventh material tray is installed on the ninth rotating mechanism. The sixth telescopic mechanism, the fifth rotating mechanism, the eighth telescopic mechanism, the seventh rotating mechanism, the tenth telescopic mechanism and the ninth rotating mechanism can drive adjustment of the workpiece body by any angle along the z-axis direction.

### 3. Beneficial Effects

Compared with the prior art, the present invention has the following advantages:
(1) The present invention can be applied to a CNC machining center or other computer numerical control devices, and material loading or unloading equipment of an assembly device. The automatic multi-process surface overturning mechanism and the positioning surface rotating mechanism can complete automatic overturning of the process surfaces and automatic rotation of the positioning surface with automatic assistance of the gripper gripping mechanism in a workpiece process switching procedure without a need to manually overturn the workpiece, which significantly saves manpower and labor. The mechanisms can complete finished product production of multi-process products independently, and therefore, a problem of switching between machining processes and problems of workpiece stacking space and retention are reduced, and an uneven ratio of machines is improved; the mechanisms make it no longer difficult or expensive to operate the machines around the clock, which fully exerts capacities of the machines; and a limitation of personnel management and uncontrollable costs in the machining industry are eliminated.
(2) A first gripper gripping mechanism and a second gripper gripping mechanism are in one group, the first gripper gripping mechanism and the second gripper gripping mechanism respectively match the first gripper and the second gripper, the third gripper gripping mechanism and the fourth gripper gripping mechanism are in one group, and the third gripper gripping mechanism and the fourth gripper gripping mechanism respectively match the third gripper and the fourth gripper. The first gripper gripping mechanism and the second gripper gripping mechanism cooperate with the first gripper and the second gripper to grip and put the machined workpiece body, and a gripper gripping direction can be set as leftward, rightward, frontward or backward according to a machining requirement; and the third gripper gripping mechanism and the fourth gripper gripping mechanism cooperate with the third gripper and the fourth gripper to grip and put the machined workpiece body, a gripper gripping direction can be set as leftward, rightward, frontward or backward according to a machining requirement, and the first rotating mechanism can be rotated by 180°, to switch between four grippers such as the first gripper.
(3) The fifth gripper of the automatic multi-process surface overturning mechanism grips the workpiece under drive of a second rotating mechanism, and the sixth gripper of the automatic multi-process surface overturning mechanism grips the workpiece and rotates by any angle around the y-axis under drive of a third rotating mechanism, to overturn the process surface of the machined workpiece body.
(4) The fourth rotating mechanism of the positioning surface rotating mechanism can drive the first material tray to rotate by any angle around the z-axis, to rotate multiple positioning surfaces of the machined workpiece body.

### BRIEF DESCRIPTION OF THE DRAWINGS

FIG. 1 is a schematic three-dimensional structural diagram of a first structure according to the present invention;

FIG. 2 is a schematic three-dimensional structural diagram of a first automatic multi-process surface overturning mechanism according to the present invention;

FIG. 3 is an exploded view of FIG. 2;

FIG. 4 is a schematic three-dimensional structural diagram of a second structure according to the present invention;

FIG. 5 is a schematic three-dimensional structural diagram of a second automatic multi-process surface overturning mechanism according to the present invention;

FIG. 6 is an exploded view of FIG. 5;

FIG. 7 is a schematic three-dimensional structural diagram of a gripper gripping mechanism according to the present invention;

FIG. 8 is an exploded view of FIG. 7; and

FIG. 9 is a schematic three-dimensional structural diagram of automatic multi-process surface overturning, positioning surface rotating and gripper gripping mechanisms according to another embodiment of the present invention.

### REFERENCE SIGNS

1.1. second gripper; 1.2. fourth gripper; 1.3. first gripper; 1.4. third gripper; 1.5. first telescopic mechanism; 1.6. second telescopic mechanism; 1.7. power mechanism of a first rotating mechanism; 1.8. first rotating mechanism; 1.9. external movement support; 2.1. fifth telescopic mechanism; 2.2. power mechanism of the fifth telescopic mechanism; 2.3. power mechanism of a fourth rotating mechanism; 2.4. fourth rotating mechanism; 2.5. third telescopic mechanism; 2.6. power mechanism of the third telescopic mechanism; 2.7. power mechanism of a second rotating mechanism; 2.8. first fixing support; 2.9. second rotating mechanism; 2.10. fifth gripper; 2.11. first material tray; 2.12. fourth telescopic mechanism; 2.13. power mechanism of a fourth telescopic mechanism; 2.14. third rotating mechanism; 2.15. sixth gripper; 2.16. power mechanism of the third rotating mechanism; 3.1. second material tray; 3.2. third material tray; 3.3. fifth rotating mechanism; 3.4. fourth material tray; 3.5. sixth telescopic mechanism; 3.6. seventh telescopic mechanism; 3.7. sixth rotating mechanism; 3.8. sixth material tray; 3.9. eighth rotating mechanism; 3.10. seventh material tray; 3.11. ninth telescopic mechanism; 3.12. tenth telescopic mechanism; 3.13. ninth rotating mechanism; 3.14. fifth material tray; 3.15. eighth telescopic mechanism; 3.16. seventh rotating mechanism; 3.17. workpiece body; 3.18. second fixing support; 2. fixing support; 3. x-axis overturning mechanism; 4. y-axis overturning mechanism; 5. z-axis positioning mechanism; and 6. gripper gripping mechanism.

### DETAILED DESCRIPTION OF EMBODIMENTS

The following clearly and completely describes the technical solutions in the embodiments of the present invention with reference to the accompanying drawings in the embodiments of the present invention. Apparently, the described embodiments are only some but not all of the embodiments of the present invention. All other embodiments obtained by persons of ordinary skills in the art based on the embodiments of the present invention without creative efforts shall fall within the protection scope of the present invention.

In the description of the present invention, it should be noted that azimuth or position relationships indicated by terms such as “upper”, “lower”, “inside”, “outside”, and “top/bottom” are based on the azimuth or position relationships shown in the accompanying drawings, and are only intended to describe the present invention and simplify the descriptions, but are not intended to indicate or imply that the specified apparatus or element shall have specific azimuth or be formed and operated at specific azimuth, and therefore cannot be understood as a limitation on the present invention. In addition, the terms “first” and “second” are only intended for a purpose of description, and shall not be understood as an indication or implication of relative importance.

In the description of the present invention, it should be noted that, unless otherwise clearly specified and limited, terms such as “installment”, “disposition”, “sleeved”, and “connection” shall be understood in a general sense. For example, “connection” may be a fixed connection, a detachable connection, or an integrated connection; or may be a mechanical connection or an electrical connection; or may be a direct connection, an indirect connection by using an intermediate medium, or an internal communication of two elements. Persons of ordinary skills in the art may understand specific meanings of the foregoing terms in the present invention according to a specific situation.

### Embodiments

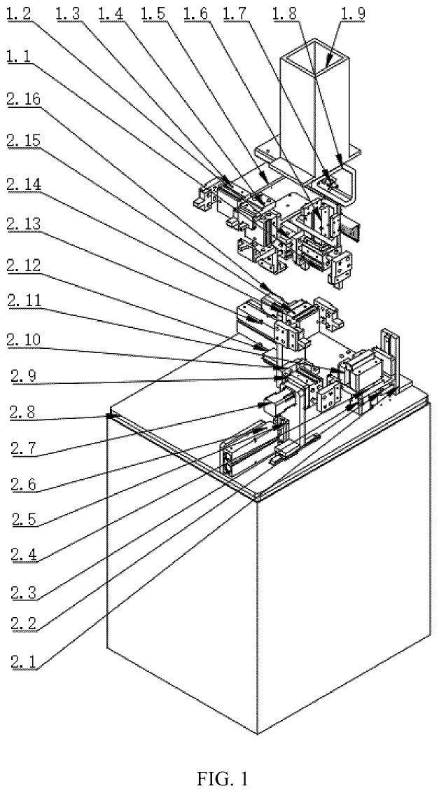

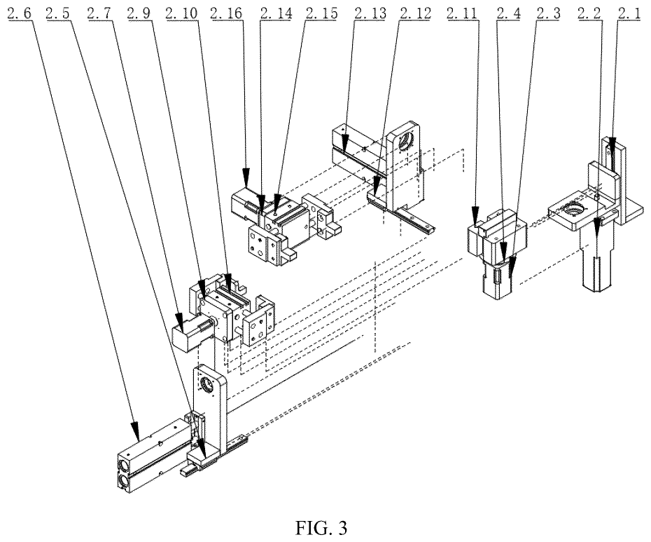

Referring to FIG. 1 to FIG. 3, automatic multi-process surface overturning, positioning surface rotating and gripper gripping mechanisms and a combined method thereof are provided and the automatic multi-process surface overturning, positioning surface rotating and gripper gripping mechanisms include a first fixing support 2.8, where the first fixing support 2.8 is configured to install the automatic multi-process surface overturning mechanism, a positioning surface rotating mechanism and a first material tray 2.11, the gripper gripping mechanism is installed on an external movement support, the gripper gripping mechanism includes a first rotating mechanism 1.8, a power mechanism 1.7 of the first rotating mechanism, a first gripper 1.3, a second gripper 1.1, a third gripper 1.4, a fourth gripper 1.2, a first telescopic mechanism 1.5, and a second telescopic mechanism 1.6, the first rotating mechanism 1.8 is installed on the external movement support 1.9, and the first telescopic mechanism 1.5 and the second telescopic mechanism 1.6 are both installed on the first rotating mechanism 1.8. The present invention can be applied to a CNC machining center or other computer numerical control devices, and material loading or unloading equipment of an assembly device. The automatic multi-process surface overturning mechanism and the positioning surface rotating mechanism can complete automatic overturning of the process surfaces and automatic rotation of the positioning surface with automatic assistance of the gripper gripping mechanism in a workpiece process switching procedure without a need to manually overturn the workpiece, which significantly saves manpower and labor. The mechanisms can complete finished product production of multi-process products independently, and therefore, a problem of switching between machining processes and problems of workpiece stacking space and retention are reduced, and an uneven ratio of machines is improved; the mechanisms make it no longer difficult or expensive to operate the machines around the clock, which fully exerts capacities of the machines; and a limitation of personnel management and uncontrollable costs in the machining industry are eliminated.

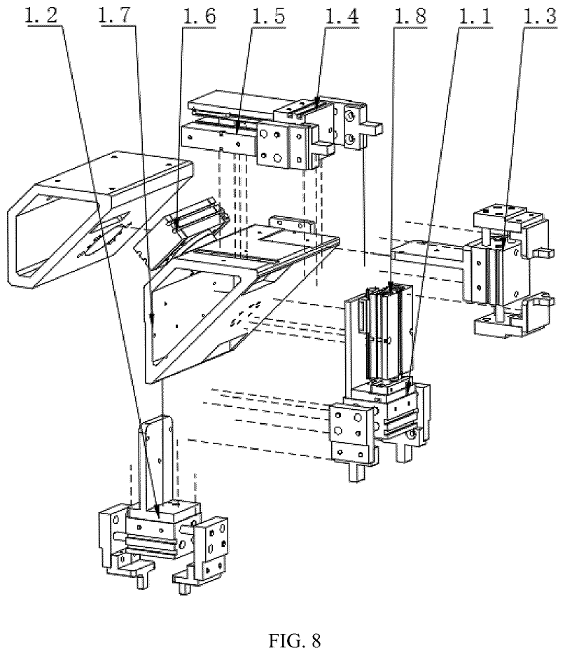

Referring to FIG. 7 and FIG. 8, a first gripper gripping mechanism and a second gripper gripping mechanism are in one group, the first gripper gripping mechanism and the second gripper gripping mechanism respectively match the first gripper 1.3 and the second gripper 1.1, the third gripper gripping mechanism and the fourth gripper gripping mechanism are in one group, and the third gripper gripping mechanism and the fourth gripper gripping mechanism respectively match the third gripper 1.4 and the fourth gripper 1.2. The first gripper gripping mechanism and the second gripper gripping mechanism cooperate with the first gripper 1.3 and the second gripper 1.1 to grip and put the machined workpiece body 3.17, and a gripper gripping direction can be set as leftward, rightward, frontward or backward according to a machining requirement; and the third gripper gripping mechanism and the fourth gripper gripping mechanism cooperate with the third gripper 1.4 and the fourth gripper 1.2 to grip and put the machined workpiece body 3.17, a gripper gripping direction can be set as leftward, rightward, frontward or backward according to a machining requirement, and the first rotating mechanism 1.8 can be rotated by 180°, to switch between four grippers such as the first gripper 1.3.

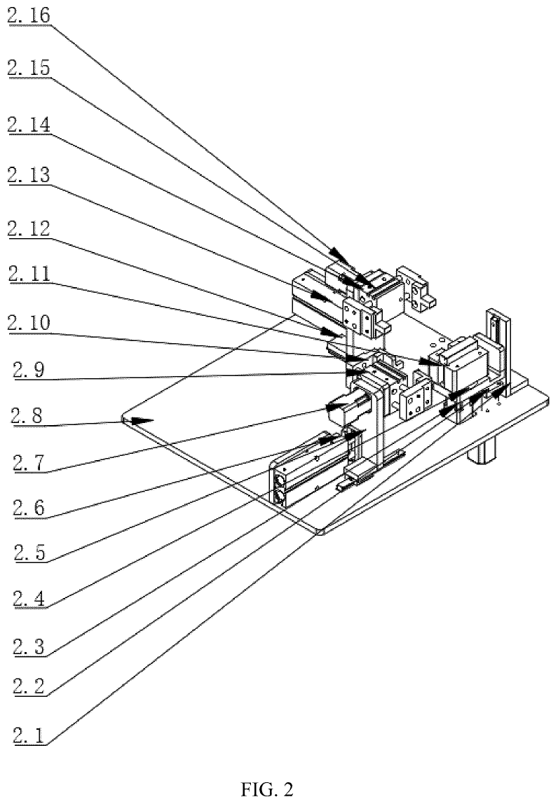

Referring to FIG. 1 and FIG. 2, the automatic multi-process surface overturning mechanism includes a third telescopic mechanism 2.5, a fourth telescopic mechanism 2.12, a second rotating mechanism 2.9, a third rotating mechanism 2.14, a fifth gripper 2.10, and a sixth gripper 2.15, the third telescopic mechanism 2.5 is equipped with a power mechanism 2.6 of third telescopic mechanism, the fourth telescopic mechanism 2.12 is equipped with a power mechanism 2.13 of the fourth telescopic mechanism, the second rotating mechanism 2.9 is equipped with a power mechanism 2.7 of the second rotating mechanism, the third rotating mechanism 2.14 is equipped with a power mechanism 2.16 of the third rotating mechanism, the third telescopic mechanism 2.5 and the fourth telescopic mechanism 2.12 are both installed on the second fixing support 3.18, the second rotating mechanism 2.9 is installed on the third telescopic mechanism 2.5, the third rotating mechanism 2.14 is installed on the fourth telescopic mechanism 2.12, the fifth gripper 2.10 is installed on the second rotating mechanism 2.9, and the sixth gripper 2.15 is installed on the third rotating mechanism 2.14. The third telescopic mechanism 2.5 drives the second rotating mechanism 2.9 and the fifth gripper 2.10 to perform linear movement along the x-axis, and the second rotating mechanism 2.9 can drive the fifth gripper 2.10 to rotate by any angle around the x-axis and drive overturning completion of the multi-process surface of the machined workpiece body 3.17; and the fourth telescopic mechanism 2.12 drives the third rotating mechanism 2.14 and the sixth gripper 2.15 to perform linear movement along the y-axis, and the third rotating mechanism 2.14 can drive the sixth gripper 2.15 to rotate by any angle around the y-axis and drive overturning completion of the multi-process surface of the machined workpiece body 3.17.

Referring to FIG. 1 to FIG. 3, the positioning surface rotating mechanism includes a fifth telescopic mechanism 2.1, a fourth rotating mechanism 2.4 and the first material tray 2.11, the fifth telescopic mechanism 2.1 is equipped with a power mechanism 2.2 of the fifth telescopic mechanism, the fourth rotating mechanism 2.4 is equipped with the power mechanism 2.3 of the fourth rotating mechanism, the fifth telescopic mechanism 2.1 is installed on the second fixing support 3.18, the fourth rotating mechanism 2.4 is installed on the fifth telescopic mechanism 2.1, and the first material tray 2.11 is installed on the fourth rotating mechanism 2.4. The fifth telescopic mechanism 2.1 drives the fourth rotating mechanism 2.4 and the first material tray 2.11 to perform linear movement along the z-axis, and the fourth rotating mechanism 2.4 can drive the first material tray 2.11 to rotate by any angle around the z-axis and drive overturning of multiple positioning surfaces of the machined workpiece body 3.17.

A first combined method of the automatic multi-process surface overturning, positioning surface rotating and gripper gripping mechanisms includes the following steps:
S1. The gripper gripping mechanism puts a workpiece body 3.17 on a first material tray 2.11 under drive of an external mechanism.
S2. A fifth telescopic mechanism 2.1 stretches and moves to a specified position according to a program setting.
S3. The third telescopic mechanism 2.5 or the fourth telescopic mechanism 2.12 stretches and the fifth gripper 2.10 or the sixth gripper 2.15 grips the workpiece body 3.17.
S4. The fifth telescopic mechanism 2.1 retracts and the second rotating mechanism 2.9 or the third rotating mechanism 2.14 completes angle rotating of the process surface of the workpiece.
S5. The fifth telescopic mechanism 2.1 stretches and moves to the specified position according to the program setting, the fifth gripper 2.10 or the sixth gripper 2.15 puts the workpiece body 3.17 back to the first material tray 2.11, the third telescopic mechanism 2.5 or the fourth telescopic mechanism 2.12 returns to an origin point, and the second rotating mechanism 2.9 or the third rotating mechanism 2.14 returns to an origin point.
S6. The fourth rotating mechanism 2.4 rotates a positioning surface of the workpiece by a rotating angle according to a program setting.
S7. The gripper gripping mechanism grips the workpiece body 3.17 under drive of an external mechanism and moves to the specified position according to the program setting, and the fifth telescopic mechanism 2.1 and the fourth rotating mechanism 2.4 return to the origin point.

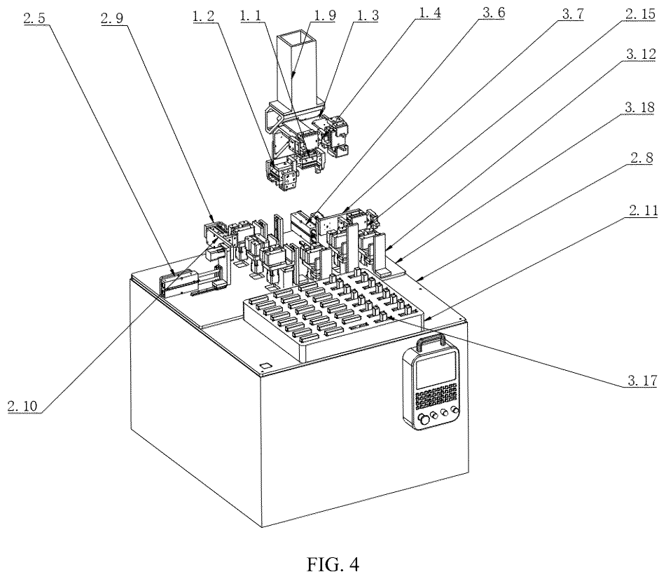

Referring to FIG. 4 to FIG. 6, the automatic multi-process surface overturning mechanism includes a third telescopic mechanism 2.5, a power mechanism 2.6 of third telescopic mechanism, a seventh telescopic mechanism 3.6, a power mechanism of the seventh telescopic mechanism, a second rotating mechanism 2.9, a power mechanism 2.7 of the second rotating mechanism, the sixth rotating mechanism 3.7, the fifth gripper 2.10, and the sixth gripper 2.15; and the seventh telescopic mechanism 3.6 is installed on the second fixing support 3.18, the sixth rotating mechanism 3.7 is installed on the seventh telescopic mechanism 3.6, the sixth rotating mechanism 3.7 is equipped with a power mechanism of the sixth rotating mechanism, and the sixth gripper 2.15 is installed on the sixth rotating mechanism 3.7. The third telescopic mechanism 2.5 can drive the second rotating mechanism 2.9 to perform telescopic movement along the x-axis, the second rotating mechanism 2.9 can drive the fifth gripper 2.10 to perform rotational movement along the x-axis direction, to overturn the machined surface of the workpiece body 3.17, and the fifth gripper 2.10 can grip and put the workpiece body 3.17; and the seventh telescopic mechanism 3.6 can drive the sixth rotating mechanism 3.7 to perform telescopic movement along the y-axis direction, the sixth rotating mechanism 3.7 can drive the sixth gripper 2.15 to perform rotational movement along the y-axis, to overturn the machined surface of the workpiece body 3.17, and the sixth gripper 2.15 can grip and put the workpiece body 3.17.

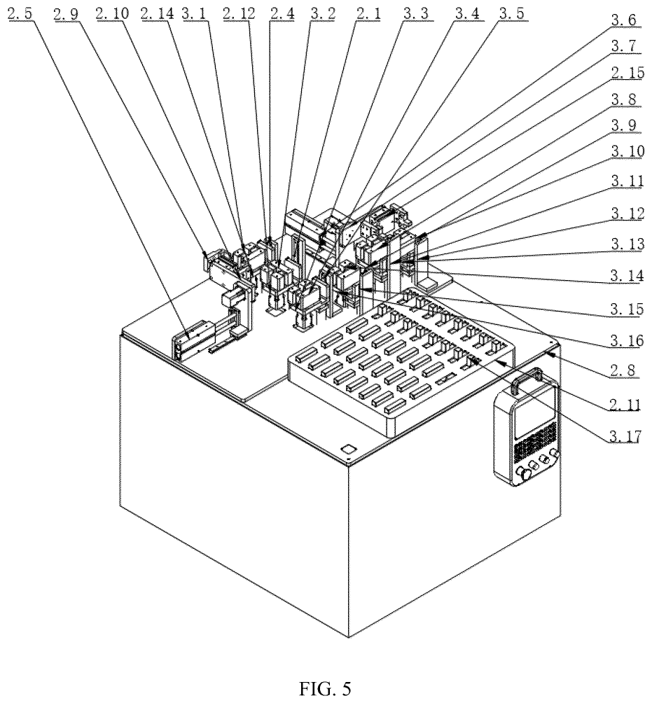

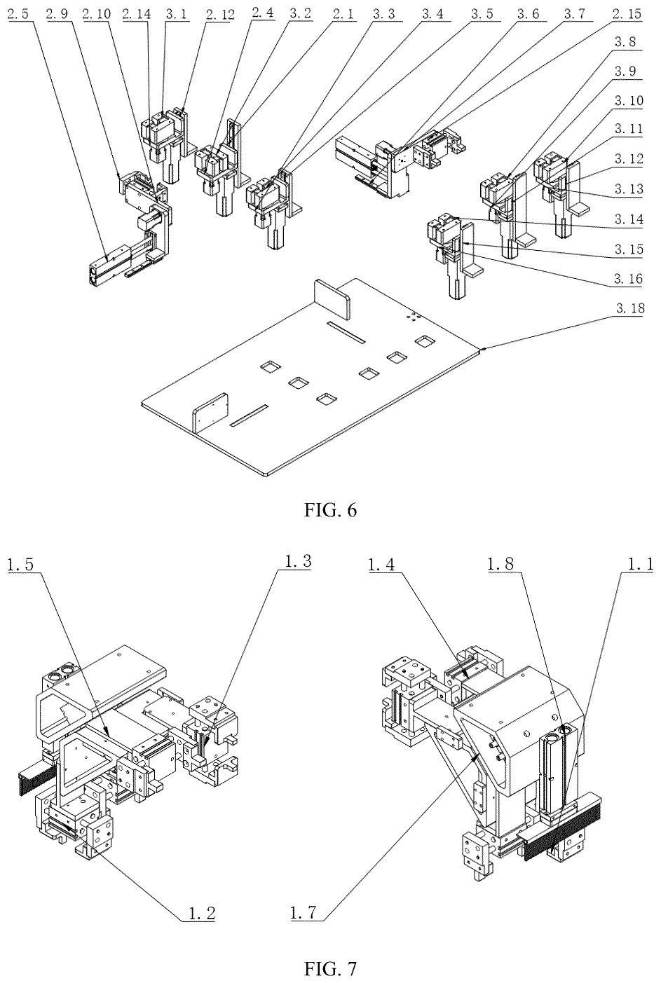

Referring to FIG. 5 and FIG. 6, the positioning surface rotating mechanism includes the fourth telescopic mechanism 2.12, the power mechanism 2.13 of the fourth telescopic mechanism, the fifth telescopic mechanism 2.1, the power mechanism 2.2 of the fifth telescopic mechanism, a sixth telescopic mechanism 3.5, a power mechanism of the sixth telescopic mechanism, an eighth telescopic mechanism 3.15, a ninth telescopic mechanism 3.11 and a tenth telescopic mechanism 3.12, and the positioning surface rotating mechanism includes the third rotating mechanism 2.14, the power mechanism 2.16 of the third rotating mechanism, the fourth rotating mechanism 2.4, the power mechanism 2.5 of the fourth rotating mechanism, the fifth rotating mechanism 3.3, the seventh rotating mechanism 3.16, an eighth rotating mechanism 3.9, a ninth rotating mechanism 3.13, a second material tray 3.1, a third material tray 3.2, a fourth material tray 3.4, a fifth material tray 3.14, a sixth material tray 3.8, and a seventh material tray 3.10. The fourth telescopic mechanism 2.12 can drive the third rotating mechanism 2.14 to perform telescopic movement along the z-axis direction, the third rotating mechanism 2.14 can drive the second material tray 3.1 to perform rotational movement along the z-axis, to rotate the positioning surface, and the second material tray 3.1 can hold the workpiece body 3.17; the fifth telescopic mechanism 2.1 can drive the fourth rotating mechanism 2.4 to perform telescopic movement along the z-axis direction, the fourth rotating mechanism 2.4 can drive the third material tray 3.2 to perform rotational movement along the z-axis, to rotate the positioning surface, and the third material tray 3.2 can hold the workpiece body 3.17; the sixth telescopic mechanism 3.5 can drive the fifth rotating mechanism 3.3 to perform telescopic movement along the z-axis direction, the fifth rotating mechanism 3.3 can drive the fourth material tray 3.4 to perform rotational movement along the z-axis, to rotate the positioning surface, and the fourth material tray 3.4 can hold the workpiece body 3.17; the eighth telescopic mechanism 3.15 can drive the seventh rotating mechanism 3.16 to perform telescopic movement along the z-axis direction, the seven rotating mechanism 3.16 can drive the fifth material tray 3.14 to perform rotational movement along the z-axis, to rotate the positioning surface, and the fifth material tray 3.14 can hold the workpiece body 3.17; the ninth telescopic mechanism 3.11 can drive the eighth rotating mechanism 3.9 to perform telescopic movement along the z-axis direction, the eighth rotating mechanism 3.9 can drive the sixth material tray 3.8 to perform rotational movement along the z-axis, to rotate the positioning surface, and the sixth material tray 3.8 can hold the workpiece body 3.17; and the tenth telescopic mechanism 3.12 can drive the ninth rotating mechanism 3.13 to perform telescopic movement along the z-axis direction, the ninth rotating mechanism 3.13 can drive the seventh material tray 3.10 to perform rotational movement along the z-axis, to rotate the positioning surface, and the seventh material tray 3.10 can hold the workpiece body 3.17.

Referring to FIG. 4 to FIG. 6, the eighth telescopic mechanism 3.15 is equipped with the power mechanism of the eighth telescopic mechanism, the ninth telescopic mechanism 3.11 is equipped with the power mechanism of the ninth telescopic mechanism, the tenth telescopic mechanism 3.12 is equipped with the power mechanism of the tenth telescopic mechanism, the fifth rotating mechanism 3.3 is equipped with the power mechanism of the fifth rotating mechanism, the seventh rotating mechanism 3.16 is equipped with the power mechanism of the seventh rotating mechanism, the eighth rotating mechanism 3.9 is equipped with the power mechanism of the eighth rotating mechanism, the ninth rotating mechanism 3.13 is equipped with the power mechanism of the ninth rotating mechanism, and the sixth telescopic mechanism 3.5, the seventh telescopic mechanism 3.6, the eighth telescopic mechanism 3.15, the ninth telescopic mechanism 3.11 and the tenth telescopic mechanism 3.12 are all installed on the first fixing support 2.8. The power mechanism of the eighth telescopic mechanism, the power mechanism of the ninth telescopic mechanism and the power mechanism of the tenth telescopic mechanism are disposed, to provide power assistance for telescopic operation of the eighth telescopic mechanism 3.15, the ninth telescopic mechanism 3.11 and the tenth telescopic mechanism 3.12. In addition, the power mechanism of the fifth rotating mechanism, the power mechanism of the seventh rotating mechanism, the power mechanism of the eighth rotating mechanism and the power mechanism of the ninth rotating mechanism provide power assistance for rotational operation of the fifth rotating mechanism 3.3, the seventh rotating mechanism 3.16, the eighth rotating mechanism 3.9 and the ninth rotating mechanism 3.13.

Referring to FIG. 4 to FIG. 6, the fifth rotating mechanism 3.3 is installed on the sixth telescopic mechanism 3.5, the seventh rotating mechanism 3.16 is installed on the eighth telescopic mechanism 3.15, the eighth rotating mechanism 3.9 is installed on the ninth telescopic mechanism 3.11, the ninth rotating mechanism 3.13 is installed on the tenth telescopic mechanism 3.12, the second material tray 3.1 is installed on the third rotating mechanism 2.14, the third material tray 3.2 is installed on the fourth rotating mechanism 2.4, the fourth material tray 3.4 is installed on the fifth rotating mechanism 3.3, and the fifth material tray 3.14 is installed on the seventh rotating mechanism 3.16, the sixth material tray 3.8 is installed on the eighth rotating mechanism 3.9, and the seventh material tray 3.10 is installed on the ninth rotating mechanism 3.13. The sixth telescopic mechanism 3.5, the fifth rotating mechanism 3.3, the eighth telescopic mechanism 3.15, the seventh rotating mechanism 3.16, the tenth telescopic mechanism 3.12 and the ninth rotating mechanism 3.13 can drive adjustment of the workpiece body 3.17 by any angle along the z-axis direction.

A second combined method of the automatic multi-process surface overturning, positioning surface rotating and gripper gripping mechanisms includes the following steps:
S1. A gripper gripping mechanism puts a workpiece body 3.17 on a second material tray 3.1 or a fifth material tray 3.14 under drive of an external mechanism.
S2. A third telescopic mechanism 2.5 or a seventh telescopic mechanism 3.6 stretches and moves to a specified position according to a program setting.
S3. A fourth telescopic mechanism 2.12 or an eighth telescopic mechanism 3.15 stretches and moves to a specified position according to a program setting.
S4. The fifth gripper 2.10 and the sixth gripper 2.15 grip the workpiece body 3.17.
S5. The second rotating mechanism 2.9 or the sixth rotating mechanism 3.7 rotates by an angle or does not rotate according to the program setting.
S6. The fifth telescopic mechanism 2.1 or the sixth telescopic mechanism 3.5, the ninth telescopic mechanism 3.11, and the tenth telescopic mechanism 3.12 stretches and moves to the specified position according to the program setting, the fifth gripper 2.10 and the sixth gripper 2.15 put the workpiece body 3.17 back to the third material tray 3.2 or the fourth material tray 3.4, the sixth material tray 3.8, and the seventh material tray 3.10, and the third telescopic mechanism 2.5 or the seventh telescopic mechanism 3.6 retracts.
S7. The third rotating mechanism 2.14 or the fourth rotating mechanism 2.4, the fifth rotating mechanism 3.3, the seventh rotating mechanism 3.16, the eighth rotating mechanism 3.9, and the ninth rotating mechanism 3.13 rotates a positioning surface of the workpiece by a rotating angle according to a program setting.
S8. The gripper gripping mechanism moves to a position adjacent to the third material tray 3.2 or the fourth material tray 3.4, the sixth material tray 3.8, and the seventh material tray 3.10 holding the workpiece body 3.17 under drive of an external mechanism, the gripper gripping mechanism grips the workpiece body 3.17, moves and puts the workpiece body 3.17 on the first material tray 2.11, and the multi-process surface overturning mechanism and the positioning surface rotating mechanism return to an origin point.

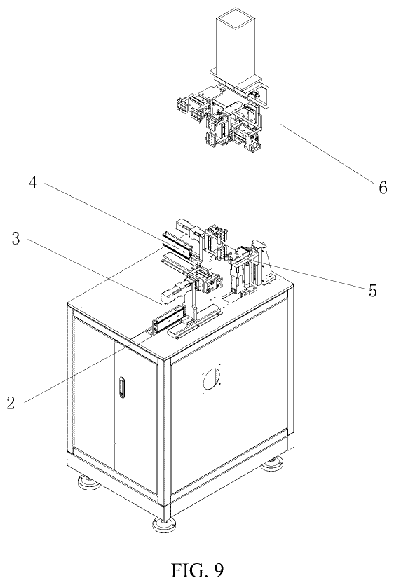

Referring to FIG. 9, in another embodiment of the present invention, automatic multi-process surface overturning, positioning surface rotating and gripper gripping mechanisms are provided. Specific structures of the automatic multi-process surface overturning, positioning surface rotating and gripper gripping mechanisms are basically the same as specific structures of the automatic multi-process surface overturning, positioning surface rotating and gripper gripping mechanisms shown in FIG. 1 to FIG. 3. In this embodiment of the present invention, the mechanisms are divided into a gripper gripping mechanism, a process surface overturning mechanism and a positioning surface rotating mechanism respectively based on functions. As shown in FIG. 9, the mechanism includes: an automatic process surface overturning mechanism, a positioning surface rotating mechanism and a gripper gripping mechanism. The gripper gripping mechanism includes at least two grippers of the gripping mechanism, the gripper gripping mechanism is installed on an external movement mechanism and configured to: grip a to-be-machined workpiece from a material platform and move to a workpiece machining device or grip a machined workpiece from the workpiece machining device under the drive of the external movement mechanism, or put the to-be-machined workpiece on the process surface overturning mechanism or remove the to-be-machined workpiece from the process surface overturning mechanism under the drive of the external movement mechanism. The process surface overturning mechanism is configured to overturn the process surface of the to-be-machined workpiece in an X-axis or Y-axis direction according to a set program. The positioning surface rotating mechanism is configured to rotate the positioning surface of the to-be-machined workpiece after the process surface overturning mechanism rotates the process surface of the to-be-machined workpiece. The automatic multi-process surface overturning, positioning surface rotating and gripper gripping mechanisms in this embodiment of the present invention serve as transfer platforms to perform procedures such as movement and overturning of the to-be-machined workpiece when the workpiece machining device machines the to-be-machined workpiece. For example, after gripping the to-be-machined workpiece, the gripper gripping mechanism moves the to-be-machined workpiece to the specified position of the workpiece machining device under the drive of the external movement mechanism, the workpiece machining device machines (for example, engraves) the current to-be-machined surface of the to-be-machined workpiece, and after the machining is completed, the external movement mechanism drives the gripper gripping mechanism to put back the preliminarily machined workpiece. When another to-be-machined surface of the to-be-machined workpiece also needs to be machined, the external movement mechanism drives the gripper gripping mechanism to move the preliminarily machined workpiece to the process surface overturning mechanism, the process surface overturning mechanism performs process surface overturning, and the external movement mechanism drives the gripper gripping mechanism to further grip and move the overturned machined workpiece to the workpiece machining device to machine another process surface. Because orientation of the positioning surface may be changed during surface overturning, when the positioning surface is needed, the process surface is overturned, then the positioning surface rotating mechanism rotates the positioning surface, and further, the gripper griping mechanism grips and moves the machined workpiece to the workpiece machining device after rotation of the positioning surface, to machine another process surface.

Specifically, in this embodiment of the present invention, the process surface overturning mechanism includes an x-axis overturning mechanism 3, a y-axis overturning mechanism 4 and a z-axis positioning mechanism 5.

The x-axis overturning mechanism 3 includes an x-axis telescopic mechanism, an x-axis rotating mechanism and an x-axis gripper; the x-axis telescopic mechanism is fixed in a positioning clamping groove in the upper end surface of the fixing support 2, the x-axis rotating mechanism is disposed at the upper end of the x-axis telescopic mechanism, the x-axis gripper is connected with the x-axis rotating mechanism, the x-axis telescopic mechanism can drive the gripper to telescope, and the x-axis rotating mechanism can drive the gripper to rotate. As shown in FIG. 11, the y-axis overturning mechanism 4 includes a y-axis telescopic mechanism, a y-axis rotating mechanism and a y-axis gripper; the y-axis telescopic mechanism is fixed in a clamping groove in the upper end surface of the fixing support 2, the y-axis rotating mechanism is disposed at the upper end of the y-axis telescopic mechanism, the y-axis gripper is connected with the y-axis rotating mechanism, the y-axis telescopic mechanism can drive the gripper to telescope, and the y-axis rotating mechanism can drive the gripper to rotate; and the x-axis overturning mechanism 3 and the y-axis overturning mechanism 4 are used for overturning the process surface of the workpiece. As shown in FIG. 12, the z-axis positioning mechanism 5 includes a z-axis material tray, a z-axis rotating mechanism enabling the material tray to rotate and a z-axis lifting mechanism for lifting the material tray; and a symmetrical center of the x-axis gripper and y-axis gripper, which is aligned with a rotating center of the z-axis rotating mechanism; the z-axis positioning mechanism 5 is configured to drive the to-be-machined workpiece to move to a first preset position, so that the x-axis overturning mechanism 3 or the y-axis overturning mechanism 4 grips the to-be-machined workpiece; and the z-axis positioning mechanism 5 also serves as the positioning surface rotating mechanism, to rotate the positioning surface of the to-be-machined workpiece. For a 6-sided machined member, there are the following 6 overturning types for the process surfaces: overturning from a right side surface to a top surface, overturning from a left side surface to the top surface, overturning from a lower bottom surface to the top surface, overturning from a front side surface to the top surface, overturning from a rear side surface to the top surface and no overturning of the process surface. There are the following 4 rotation types for the positioning surface: rotation from a right side surface to a rear side surface, rotation from a left side surface to the rear side surface, rotation from a front side surface to the rear side surface and no rotation of the positioning surface.

The gripper gripping mechanism 6 includes: a fixing support of the gripping mechanism, a rotating mechanism of the gripping mechanism, four grippers of the gripping mechanism, and two telescopic mechanisms of the gripping mechanism; the gripper gripping mechanism 6 is connected with an external movement mechanism through the fixing support of the gripping mechanism; the rotating mechanism of the gripping mechanism is installed at a lower end of the fixing support of the gripping mechanism; the two telescopic mechanisms of the gripping mechanism are respectively: a first telescopic mechanism of the gripping mechanism and a second telescopic mechanism of the gripping mechanism, and are disposed on two fixed surfaces of the rotating mechanism of the gripping mechanism, and the two telescopic mechanisms of the gripping mechanism are perpendicular to each other; the four grippers of the gripping mechanism are respectively: a gripper 1, a gripper 2, a gripper 3 and a gripper 4; and the gripper gripping mechanism 6 is used for gripping and putting the workpiece, transferring the workpiece to the transfer platform under the drive of the movement mechanism, or loading or unloading a material onto or off a device.

Another embodiment of the present invention provides automatic multi-process surface overturning, positioning surface rotating and gripper gripping methods, and the methods are based on the automatic multi-process surface overturning, positioning surface rotating and gripper gripping mechanisms in the foregoing Embodiment 3. The method includes:
Step 101: According to a process machining requirement of the to-be-machined workpiece, determine an operation sequence and target execution motions of components in the automatic process surface overturning mechanism, the positioning surface rotating mechanism and the gripper gripping mechanism, according to the operation sequence and the target execution motions, select target operation methods corresponding to the automatic process surface overturning mechanism, the positioning surface rotating mechanism and the gripper gripping mechanism from a program library, and combine the target operation methods to obtain a current execution procedure method, where the program library prestores a combined method of multiple process surface overturning methods corresponding to the automatic process surface overturning mechanism, multiple positioning surface rotating methods corresponding to the positioning surface rotating mechanism and multiple gripper gripping methods corresponding to the multiple execution motions of components corresponding to the gripper gripping mechanism.
Step 102: Control the components in the automatic process surface overturning mechanism, the positioning surface rotating mechanism and the gripper gripping mechanism to perform an operation on the to-be-machined workpiece according to the current execution procedure method.

The to-be-machined workpiece may be a six-sided cube. The program library includes 6 process surface overturning methods corresponding to the automatic process surface overturning mechanism, 4 positioning surface rotating methods corresponding to the positioning surface rotating mechanism and 8 gripper gripping methods corresponding to the gripper gripping mechanism. The 6 process surface overturning methods include: overturning from a right side surface to a top surface, overturning from a left side surface to the top surface, overturning from a lower bottom surface to the top surface, overturning from a front side surface to the top surface, overturning from a rear side surface to the top surface and no overturning of the process surface. 4 positioning surface rotating methods include: rotation from a right side surface to a rear side surface, rotation from a left side surface to the rear side surface, rotation from a front side surface to the rear side surface and no rotation of the positioning surface. In this embodiment of the present invention, there are the following 8 gripping combinations of the grippers: workpiece loading of the gripper 1, workpiece unloading of the gripper 2, and workpiece picking of the gripper 1 after overturning; workpiece loading of the gripper 1, workpiece unloading of the gripper 2, and workpiece picking of the gripper 2 after overturning; workpiece loading of the gripper 1, workpiece unloading of the gripper 2, and workpiece picking of the gripper 3 after overturning; workpiece loading of the gripper 1, workpiece unloading of the gripper 3, and workpiece picking of the gripper 2 after overturning; workpiece loading of the gripper 1, workpiece unloading of the gripper 3, and workpiece picking of the gripper 3 after overturning; workpiece loading of the gripper 2, workpiece unloading of the gripper 3, and workpiece picking of the gripper 2 after overturning; workpiece loading of the gripper 2, workpiece unloading of the gripper 3, and workpiece picking of the gripper 3 after overturning; and workpiece loading of the gripper 3, workpiece unloading of the gripper 4, and workpiece picking of the gripper 3 after overturning. In the automatic multi-process surface overturning, positioning surface rotating and gripper gripping methods, the combined method of 6 process surface overturning methods, 4 positioning surface rotating methods and 8 gripper gripping methods are respectively written into the preset program library, in machining processes of different to-be-machined workpieces, the corresponding process surface overturning method, positioning surface rotating method and gripper gripping method can be selected from the combined method of 6 process surface overturning methods, 4 positioning surface rotating methods and 8 gripper gripping methods, to edit a set corresponding program and path, so that a current execution procedure method is formed for the current to-be-machined workpiece, thereby effectively reducing a program edition procedure and resolving problems of complex edition logic and high costs in an existing method of using, for example, an articulated robot. In the combined method of 6 set process surface overturning methods, 4 positioning surface rotating methods and 8 gripper gripping methods, when operators replace machining parts or assembly parts of a CNC machining center or other computer numerical control devices, there is no need to re-edit motions and paths for loading or unloading materials, and only appropriate material loading or unloading motions and paths need to be selected and a size of the gripper needs to be adjusted based on process requirements. This reduces time of debugging and lowers difficulty of debugging.

In a specific embodiment, there are two types of process flows of gripping the workpiece by the gripper gripping mechanism 6 to load or unload the material onto or off the device: A first process flow A is as follows: workpiece loading, workpiece machining, and workpiece unloading, where the automatic process surface overturning mechanism and the positioning surface rotating mechanism do not work in this process flow. A second process flow B is as follows: workpiece loading, workpiece machining, workpiece unloading, workpiece overturning at a transfer platform, secondary workpiece loading, secondary workpiece machining, and secondary workpiece unloading, where the automatic process surface overturning mechanism and the positioning surface rotating mechanism work in this process flow.

In the first process flow A of the combined method of the automatic multi-process surface overturning, positioning surface rotating and gripper gripping mechanisms, a flow for loading or unloading a material onto or off a computer numerical control device (workpiece machining device) is as follows:

Assuming that a material platform is loaded with the material, unmachined workpieces are sorted in a sequence of a, b, c, . . . . Correspondingly, workpieces machined in the first process are a1, b1, c1, . . . , and workpieces machined in the second process are a2, b2, c2, . . .

First material loading or unloading steps of the process flow A are as follows:
A1. Put an unmachined workpiece on the material platform; and the gripper gripping mechanism moves to the top of the material platform under drive of an external mechanism, the gripper gripping mechanism rotates or moves to a next working position of the gripper 1 (the gripper can be selected according to a process requirement, which is the same case below), the gripper 1 of the gripper gripping mechanism grips the unmachined workpiece a.
A2. According to a program setting, the gripper gripping mechanism moves to the top of the workpiece clamping position of the computer numerical control device under the drive of the external mechanism, the gripper gripping mechanism rotates or moves to a next working position of the gripper 2, and the gripper 2 moves and grips a machined workpiece at the workpiece clamping position of the computer numerical control device under the drive of the external mechanism (there is no machined workpiece in the first step, which is the same case below).
A3. The gripper gripping mechanism rotates or moves to a next working position of the gripper 1, and the gripper 1 moves under the drive of the external mechanism and puts an unmachined workpiece a at a workpiece clamping position of the computer numerical control device.
A4. The gripper gripping mechanism clamps a machined workpiece, and leaves the computer numerical control device under the drive of the external mechanism, and the computer numerical control device begins to machine the unmachined workpiece a.
A5. The gripper gripping mechanism clamps the machined workpiece and moves to the top of the material platform under the drive of the external mechanism, the gripper gripping mechanism rotates or moves to a next working position of the gripper 2, and the gripper 2 moves and puts the machined workpiece at a correspondingly numbered position of the material platform under the drive of the external mechanism.

Second material loading or unloading steps of the process flow A are as follows:
A6. The gripper gripping mechanism rotates or moves to a next working position of the gripper 1, and the gripper 1 of the gripper gripping mechanism grips the unmachined workpiece b.
A7. The gripper gripping mechanism moves to the periphery of the computer numerical control device under the drive of the external mechanism to wait for machining of the previous workpiece according to a program setting.
A8. The computer numerical control device completes a machining process of the unmachined workpiece a.
A9. According to a program setting, the gripper gripping mechanism moves to the top of the workpiece clamping position of the computer numerical control device under the drive of the external mechanism, the gripper gripping mechanism rotates or moves to a next working position of the gripper 2, and the gripper 2 moves and grips a machined workpiece a1 at the workpiece clamping position of the computer numerical control device under the drive of the external mechanism.
A10. The gripper gripping mechanism rotates or moves to a next working position of the gripper 1, and the gripper 1 moves under the drive of the external mechanism and puts an unmachined workpiece b at a workpiece clamping position of the computer numerical control device.
A11. The gripper 2 of the gripper gripping mechanism clamps a machined workpiece a1, and leaves the computer numerical control device under the drive of the external mechanism, and the computer numerical control device begins to machine the unmachined workpiece b.
A12. The gripper gripping mechanism clamps the machined workpiece a1 and moves to the top of the material platform under the drive of the external mechanism, the gripper gripping mechanism rotates or moves to a next working position of the gripper 2, and the gripper 2 moves and puts the machined workpiece a1at a correspondingly numbered position of the material platform under the drive of the external mechanism.
A13. Third material loading or unloading steps of the process flow A (and subsequent material loading or unloading of all workpieces) are the same as the second material loading or unloading steps of the process flow A; and cyclically repeat steps A6 to A12 continuously, to automatically complete loading or unloading of the materials in process flows A of all the workpieces on the material platform.

Because there are many types of combined methods of the automatic multi-process surface overturning, positioning surface rotating and gripper gripping mechanisms, for rotation of the process surface of the workpiece, a preset selection program of “overturning from a lower bottom surface to the top surface”, “no rotation of the positioning surface”, or “workpiece loading of the gripper 1, workpiece unloading of the gripper 2, and workpiece picking of the gripper 1 after overturning” is used as an example for description, and first material loading or unloading steps of the first process in the process flow B are as follows:
B1. Put an unmachined workpiece on the material platform; and the gripper gripping mechanism moves to the top of the material platform under drive of an external mechanism, the gripper gripping mechanism rotates or moves to a next working position of the gripper 1 (the gripper is selected according to a process requirement, which is the same case below), the gripper 1 of the gripper gripping mechanism grips the unmachined workpiece a.
B2. According to a program setting, the gripper gripping mechanism moves to the top of the workpiece clamping position of the computer numerical control device under the drive of the external mechanism, the gripper gripping mechanism rotates or moves to a next working position of the gripper 2, and the gripper 2 moves and grips a machined workpiece at the workpiece clamping position of the computer numerical control device under the drive of the external mechanism (there is no machined workpiece in the first step, which is the same case below).
B3. The gripper gripping mechanism rotates or moves to a next working position of the gripper 1, and the gripper 1 moves under the drive of the external mechanism and puts an unmachined workpiece a at a workpiece clamping position of the computer numerical control device.
B4. The gripper 2 of the gripper gripping mechanism clamps a machined workpiece, and leaves the computer numerical control device under the drive of the external mechanism, and the computer numerical control device begins to machine the unmachined workpiece a.

B5. The gripper gripping mechanism clamps the machined workpiece and moves to the top of the transfer platform under the drive of the external mechanism, the gripper gripping mechanism rotates or moves to a next working position of the gripper 2, and the gripper 2 moves and puts the machined workpiece at the z-axis material tray under the drive of the external mechanism according to the program setting.
B6. According to the program setting, the z-axis material tray descends to a proper position under the drive of the z-axis lifting mechanism.
B7. According to the program setting, fingers of the x-axis gripper (the gripper is selected according to the process requirements, which is the same case below) open and stretch out under the drive of the x-axis telescopic mechanism, and the fingers of the x-axis gripper tightly clamp and grip the machined workpiece.
B8. According to the program setting, the z-axis material tray descends to a proper position under the drive of the z-axis lifting mechanism, and the z-axis material tray is detached from the machined workpiece.
B9. According to the program setting, the x-axis gripper telescopes under the drive of the x-axis telescopic mechanism, and the x-axis gripper rotates by 180 degrees under the drive of the x-axis rotating mechanism to complete overturning of the process surface required for the next process.
B10. According to the program setting, the x-axis gripper stretches out under the drive of the x-axis telescopic mechanism, the z-axis material tray ascends to a proper position under the drive of the z-axis lifting mechanism, the z-axis material tray supports the machined workpiece, fingers of the x-axis gripper open and put the machined workpiece on the z-axis material tray, and the x-axis gripper returns to an original point under the drive of the x-axis telescopic mechanism and the x-axis rotating mechanism.
B11. According to the program setting, the z-axis material tray rotates by the preset angle under the drive of the z-axis rotating mechanism (the positioning surface does not need to be rotated in this example), to complete rotation of the positioning surface required for the next process.
B12. According to the program setting, the z-axis material tray ascends to a proper position under the drive of the z-axis lifting mechanism, the gripper gripping mechanism rotates or moves to a next working position of the gripper 1, and the gripper 1 grips the machined workpiece.
B13. According to the program setting, the z-axis material tray returns to an original point under the drive of the z-axis lifting mechanism and the z-axis rotating mechanism.
B14. According to the program setting, the gripper gripping mechanism clamps the machined workpiece and moves to the top of the material platform under the drive of the external movement mechanism, and puts the machined workpiece at a correspondingly numbered position of the material platform.

Second material loading or unloading steps of the first process in the process flow B are as follows:
B15. The gripper gripping mechanism rotates or moves to a next working position of the gripper 1, and the gripper 1 of the gripper gripping mechanism grips the unmachined workpiece b.
B16. The gripper gripping mechanism moves to the periphery of the computer numerical control device under the drive of the external mechanism to wait for machining of the previous workpiece according to a program setting.
B17. The computer numerical control device completes a machining process of the unmachined workpiece a.

B18. According to a program setting, the gripper gripping mechanism moves to the top of the workpiece clamping position of the computer numerical control device under the drive of the external mechanism, the gripper gripping mechanism rotates or moves to a next working position of the gripper 2, and the gripper 2 moves and grips a machined workpiece a1 at the workpiece clamping position of the computer numerical control device under the drive of the external mechanism.
B19. The gripper gripping mechanism rotates or moves to a next working position of the gripper 1, and the gripper 1 moves under the drive of the external mechanism and puts an unmachined workpiece b at a workpiece clamping position of the computer numerical control device.
B20. The gripper gripping mechanism clamps a machined workpiece, and leaves the computer numerical control device under the drive of the external mechanism, and the computer numerical control device begins to machine the unmachined workpiece b.
B21. The gripper gripping mechanism clamps the machined workpiece a1 and moves to the top of the transfer platform under the drive of the external mechanism, the gripper gripping mechanism rotates or moves to a next working position of the gripper 2, and the gripper 2 moves and puts the machined workpiece a1 at the z-axis material tray under the drive of the external mechanism according to the program setting.
B22. According to the program setting, the z-axis material tray descends to a proper position under the drive of the z-axis lifting mechanism.
B23. According to the program setting, fingers of the x-axis gripper open and stretch out under the drive of the x-axis telescopic mechanism, and the fingers of the x-axis gripper tightly clamp and grip the machined workpiece.
B24. According to the program setting, the z-axis material tray descends to a proper position under the drive of the z-axis lifting mechanism, and the z-axis material tray is detached from the machined workpiece.
B25. According to the program setting, the x-axis gripper telescopes under the drive of the x-axis telescopic mechanism, and the x-axis gripper rotates by 180 degrees under the drive of the x-axis rotating mechanism to complete overturning of the process surface required for the next process.
B26. According to the program setting, the x-axis gripper stretches out under the drive of the x-axis telescopic mechanism, the z-axis material tray ascends to a proper position under the drive of the z-axis lifting mechanism, the z-axis material tray supports the machined workpiece, fingers of the x-axis gripper open and put the machined workpiece on the z-axis material tray, and the x-axis gripper returns to an original point under the drive of the x-axis telescopic mechanism and the x-axis rotating mechanism.
B27. According to the program setting, the z-axis material tray rotates by the preset angle under the drive of the z-axis rotating mechanism (the positioning surface does not need to be rotated in this example), to complete rotation of the positioning surface required for the next process.
B28. According to the program setting, the z-axis material tray ascends to a proper position under the drive of the z-axis lifting mechanism, the gripper gripping mechanism rotates or moves to a next working position of the gripper 1, and the gripper 1 grips the machined workpiece.
B29. According to the program setting, the z-axis material tray returns to an original point under the drive of the z-axis lifting mechanism and the z-axis rotating mechanism.
B30. According to the program setting, the gripper gripping mechanism clamps the machined workpiece and moves to the top of the material platform under the drive of the external movement mechanism, and puts the machined workpiece at a correspondingly numbered position of the material platform.
B31. Third material loading or unloading steps of the first process in the process flow B (and subsequent material loading or unloading of all workpieces) are the same as the second material loading or unloading steps of the first process in the process flow B; and cyclically repeat steps B15 to B30 continuously, to automatically complete loading or unloading of the materials in the first process of process flows of all the workpieces on the material platform.

First material loading or unloading steps of the second process in the process flow B are as follows:
B32. The gripper gripping mechanism rotates or moves to a next working position of the gripper 1, the gripper gripping mechanism moves to the top of the material platform under drive of the external mechanism, and the gripper 1 of the gripper gripping mechanism grips the to-be-machined workpiece a1.
B33. According to a program setting, the gripper gripping mechanism moves to the top of the workpiece clamping position of the computer numerical control device under the drive of the external mechanism, the gripper gripping mechanism rotates or moves to a next working position of the gripper 2, and the gripper 2 moves and grips a machined workpiece at the workpiece clamping position of the computer numerical control device under the drive of the external mechanism (there is no machined workpiece in the first step, which is the same case below).
B34. The gripper gripping mechanism rotates or moves to a next working position of the gripper 1, and the gripper 1 moves under the drive of the external mechanism and puts an unmachined workpiece a1 at a workpiece clamping position of the computer numerical control device.
B35. The gripper gripping mechanism clamps a machined workpiece, and leaves the computer numerical control device under the drive of the external mechanism, and the computer numerical control device begins to machine the unmachined workpiece a1.
B36. According to the program setting, the gripper gripping mechanism clamps the machined workpiece and moves to the top of the material platform under the drive of the external movement mechanism, the gripper gripping mechanism rotates or moves to a next working position of the gripper 2, and puts the machined workpiece a1 at a correspondingly numbered position of the material platform.

Second material loading or unloading steps of the second process in the process flow B are as follows:
B37. The gripper gripping mechanism rotates or moves to a next working position of the gripper 1, and the gripper 1 of the gripper gripping mechanism grips the to-be-machined workpiece b1.

B38. The gripper gripping mechanism moves to the periphery of the computer numerical control device under the drive of the external mechanism to wait for machining of the previous workpiece according to a program setting.

B39. The computer numerical control device completes a machining process of the unmachined workpiece a1.

B40. According to a program setting, the gripper gripping mechanism moves to the top of the workpiece clamping position of the computer numerical control device under the drive of the external mechanism, the gripper gripping mechanism rotates or moves to a next working position of the gripper 2, and the gripper 2 moves and grips a machined workpiece a1 at the workpiece clamping position of the computer numerical control device under the drive of the external mechanism.
B41. The gripper gripping mechanism rotates or moves to a next working position of the gripper 1, and the gripper 1 moves under the drive of the external mechanism and puts an unmachined workpiece b1 at a workpiece clamping position of the computer numerical control device.
B42. The gripper gripping mechanism clamps a machined workpiece a2, and leaves the computer numerical control device under the drive of the external mechanism, and the computer numerical control device begins to machine the unmachined workpiece b1.
B43. The gripper gripping mechanism clamps the machined workpiece a2 and moves to the top of the material platform under the drive of the external mechanism, the gripper gripping mechanism rotates or moves to a next working position of the gripper 2, and the gripper 2 moves and puts the machined workpiece a2 at a correspondingly numbered position of the material platform under the drive of the external mechanism.
B44. Third material loading or unloading steps of the process flow B (and subsequent material loading or unloading of all workpieces) are the same as the second material loading or unloading steps of the process flow B; and cyclically repeat steps B37 to B43 continuously, to automatically complete loading or unloading of the materials in the second process of process flows B of all the workpieces on the material platform.

For a workpiece requiring more than two machining processes, material loading or unloading process flows of all workpieces in the first process of the workpieces (and subsequent material loading or unloading process flows of all the workpieces in all processes except the last process) are the same as the material loading or unloading process flow in the first process of the foregoing process flow B, and cyclically repeating steps B1 to B31 can complete loading or unloading of materials, overturning of the process surfaces and rotation of the positioning surfaces of all the workpieces in the first process of the workpieces (and subsequent material loading or unloading process flows of all the workpieces in all processes except the last process). Material loading or unloading process flows of all workpieces in the last process of the workpieces are the same as the material loading or unloading process flow in the second process of the foregoing process flow B, and cyclically repeating steps B32 to B44 can complete loading or unloading of materials, overturning of the process surfaces and rotation of the positioning surfaces of all the workpieces in the last process of the workpieces.

The foregoing embodiments are only preferred embodiments of the present invention, but the protection scope of the present invention is not limited thereto. Equivalent replacements or changes made by any person skilled in the art to the technical solution of the present invention and an improved idea thereof within the disclosed technical scope of the present invention shall fall within the protection scope of the present invention.

Automatic multi-process surface overturning, positioning surface rotating and gripper gripping mechanisms and a combined method thereof are provided, where the automatic multi-process surface overturning, positioning surface rotating and gripper gripping mechanisms include a first fixing support (2.8), where the first fixing support (2.8) is configured to install the automatic multi-process surface overturning mechanism, a positioning surface rotating mechanism and a first material tray (2.11), the gripper gripping mechanism is installed on an external movement support (1.9), the gripper gripping mechanism includes a first rotating mechanism (1.8), a power mechanism (1.7) of the first rotating mechanism, a first gripper (1.3), a second gripper (1.1), a third gripper (1.4), a fourth gripper (1.2), a first telescopic mechanism (1.5), and a second telescopic mechanism (1.6), the first rotating mechanism (1.8) is installed on the external movement support (1.9), and the first telescopic mechanism (1.5) and the second telescopic mechanism (1.6) are both installed on the first rotating mechanism (1.8).

What is claimed is:

1. Automatic multi-process surface overturning, positioning surface rotating and gripper gripping mechanisms, comprising a first fixing support (2.8), wherein the first fixing support (2.8) is configured to install the automatic multi-process surface overturning mechanism, a positioning surface rotating mechanism and a first material tray (2.11), the gripper gripping mechanism is installed on an external movement support, the gripper gripping mechanism comprises a first rotating mechanism (1.8), a power mechanism (1.7) of the first rotating mechanism, a first gripper (1.3), a second gripper (1.1), a third gripper (1.4), a fourth gripper (1.2), a first telescopic mechanism (1.5), and a second telescopic mechanism (1.6), the first rotating mechanism (1.8) is installed on the external movement support (1.9), and the first telescopic mechanism (1.5) and the second telescopic mechanism (1.6) are both installed on the first rotating mechanism (1.8).

2. The automatic multi-process surface overturning, positioning surface rotating and gripper gripping mechanisms according to claim 1, wherein a first gripper gripping mechanism and a second gripper gripping mechanism are in one group, the first gripper gripping mechanism and the second gripper gripping mechanism respectively match the first gripper (1.3) and the second gripper (1.1), the third gripper gripping mechanism and the fourth gripper gripping mechanism are in one group, and the third gripper gripping mechanism and the fourth gripper gripping mechanism respectively match the third gripper (1.4) and the fourth gripper (1.2).

3. The automatic multi-process surface overturning, positioning surface rotating and gripper gripping mechanisms according to claim 1, wherein the automatic multi-process surface overturning mechanism comprises a third telescopic mechanism (2.5), a fourth telescopic mechanism (2.12), a second rotating mechanism (2.9), a third rotating mechanism (2.14), a fifth gripper (2.10), and a sixth gripper (2.15), the third telescopic mechanism (2.5) is equipped with a power mechanism (2.6) of the third telescopic mechanism, the fourth telescopic mechanism (2.12) is equipped with a power mechanism (2.13) of the fourth telescopic mechanism, the second rotating mechanism (2.9) is equipped with a power mechanism (2.7) of the second rotating mechanism, the third rotating mechanism (2.14) is equipped with a power mechanism (2.16) of the third rotating mechanism, the third telescopic mechanism (2.5) and the fourth telescopic mechanism (2.12) are both installed on the second fixing support (3.18), the second rotating mechanism (2.9) is installed on the third telescopic mechanism (2.5), the third rotating mechanism (2.14) is installed on the fourth telescopic mechanism (2.12), the fifth gripper (2.10) is installed on the second rotating mechanism (2.9), and the sixth gripper (2.15) is installed on the third rotating mechanism (2.14); and
the automatic multi-process surface overturning mechanism comprises a third telescopic mechanism (2.5), a power mechanism (2.6) of the third telescopic mechanism, a seventh telescopic mechanism (3.6), a power mechanism of the seventh telescopic mechanism, a second rotating mechanism (2.9), a power mechanism (2.7) of the second rotating mechanism, the sixth rotating mechanism (3.7), the fifth gripper (2.10), and the sixth gripper (2.15); and the seventh telescopic mechanism (3.6) is installed on the second fixing support (3.18), the sixth rotating mechanism (3.7) is installed on the seventh telescopic mechanism (3.6), the sixth rotating mechanism (3.7) is equipped with a power mechanism of the sixth rotating mechanism, and the sixth gripper (2.15) is installed on the sixth rotating mechanism (3.7).

4. The automatic multi-process surface overturning, positioning surface rotating and gripper gripping mechanisms according to claim 3, wherein the positioning surface rotating mechanism comprises a fifth telescopic mechanism (2.1), a fourth rotating mechanism (2.4) and the first material tray (2.11), the fifth telescopic mechanism (2.1) is equipped with a power mechanism (2.2) of the fifth telescopic mechanism, the fourth rotating mechanism (2.4) is equipped with the power mechanism (2.3) of the fourth rotating mechanism, the fifth telescopic mechanism (2.1) is installed on the second fixing support (3.18), the fourth rotating mechanism (2.4) is installed on the fifth telescopic mechanism (2.1), and the first material tray (2.11) is installed on the fourth rotating mechanism (2.4); and
the positioning surface rotating mechanism comprises the fourth telescopic mechanism (2.12), the power mechanism (2.13) of the fourth telescopic mechanism, the fifth telescopic mechanism (2.1), the power mechanism (2.2) of the fifth telescopic mechanism, a sixth telescopic mechanism (3.5), a power mechanism of the sixth telescopic mechanism, an eighth telescopic mechanism (3.15), a ninth telescopic mechanism (3.11) and a tenth telescopic mechanism (3.12), and the positioning surface rotating mechanism comprises the third rotating mechanism (2.14), the power mechanism (2.16) of the third rotating mechanism, the fourth rotating mechanism (2.4), the power mechanism (2.5) of the fourth rotating mechanism, the fifth rotating mechanism (3.3), the seventh rotating mechanism (3.16), an eighth rotating mechanism (3.9), a ninth rotating mechanism (3.13), a second material tray (3.1), a third material tray (3.2), a fourth material tray (3.4), a fifth material tray (3.14), a sixth material tray (3.8), and a seventh material tray (3.10).

5. The automatic multi-process surface overturning, positioning surface rotating and gripper gripping mechanisms according to claim 4, wherein the eighth telescopic mechanism (3.15) is equipped with the power mechanism of the eighth telescopic mechanism, the ninth telescopic mechanism (3.11) is equipped with the power mechanism of the ninth telescopic mechanism, the tenth telescopic mechanism (3.12) is equipped with the power mechanism of the tenth telescopic mechanism, the fifth rotating mechanism (3.3) is equipped with the power mechanism of the fifth rotating mechanism, the seventh rotating mechanism (3.16) is equipped with the power mechanism of the seventh rotating mechanism, the eighth rotating mechanism (3.9) is equipped with the power mechanism of the eighth rotating mechanism, the ninth rotating mechanism (3.13) is equipped with the power mechanism of the ninth rotating mechanism, and the sixth telescopic mechanism (3.5), the seventh telescopic mechanism (3.6), the eighth telescopic mechanism (3.15), the ninth telescopic mechanism (3.11) and the tenth telescopic mechanism (3.12) are all installed on the first fixing support (2.8).

6. Automatic multi-process surface overturning, positioning surface rotating and gripper gripping methods, wherein the methods are based on the automatic multi-process surface overturning, positioning surface rotating and gripper gripping mechanisms according to claim 1, and the method comprises:
S1: putting, by the gripper gripping mechanism, a workpiece body (3.17) on a first material tray (2.11) under drive of an external mechanism;
S2: stretching by a fifth telescopic mechanism (2.1) and moving to a specified position according to a program setting;
S3: stretching by the third telescopic mechanism (2.5) or the fourth telescopic mechanism (2.12), and gripping, by the fifth gripper (2.10) or the sixth gripper (2.15), the workpiece body (3.17);
S4: retracting by the fifth telescopic mechanism (2.1), and completing, by the second rotating mechanism (2.9) or the third rotating mechanism (2.14), angle rotating of the process surface of the workpiece;
S5: stretching by the fifth telescopic mechanism (2.1) and moving to the specified position according to the program setting, putting, by the fifth gripper (2.10) or the sixth gripper (2.15), the workpiece body (3.17) back to the first material tray (2.11), returning, by the third telescopic mechanism (2.5) or the fourth telescopic mechanism (2.12), to an origin point, and returning, by the second rotating mechanism (2.9) or the third rotating mechanism (2.14), to an origin point;
S6: rotating, by the fourth rotating mechanism (2.4), a positioning surface of the workpiece by a rotating angle according to a program setting; and
S7: gripping, by the gripper gripping mechanism, the workpiece body (3.17) under drive of an external mechanism and moving to the specified position according to the program setting, and returning, by the fifth telescopic mechanism (2.1) and the fourth rotating mechanism (2.4), to the origin point.

7. Automatic multi-process surface overturning, positioning surface rotating and gripper gripping methods, wherein the methods are based on automatic multi-process surface overturning, positioning surface rotating and gripper gripping mechanisms; the automatic multi-process surface overturning, positioning surface rotating and gripper gripping mechanisms comprise: an automatic process surface overturning mechanism, a positioning surface rotating mechanism and a gripper gripping mechanism; the gripper gripping mechanism comprises at least two grippers of the gripping mechanism, the gripper gripping mechanism is installed on an external movement mechanism and configured to: grip a to-be-machined workpiece from a material platform and move to a workpiece machining device or grip a machined workpiece from the workpiece machining device under the drive of the external movement mechanism, or put the to-be-machined workpiece on the process surface overturning mechanism or remove the to-be-machined workpiece from the process surface overturning mechanism under the drive of the external movement mechanism; the process surface overturning mechanism is configured to overturn the process surface of the to-be-machined workpiece in an X-axis or Y-axis direction according to a set program; and the positioning surface rotating mechanism is configured to rotate the positioning surface of the to-be-machined workpiece after the process surface overturning mechanism rotates the process surface of the to-be-machined workpiece; and
The method comprises:
according to a process machining requirement of the to-be-machined workpiece, determining an operation sequence and target execution motions of components in the automatic process surface overturning mechanism, the positioning surface rotating mechanism and the gripper gripping mechanism, according to the operation sequence and the target execution motions, selecting target operation methods corresponding to the automatic process surface overturning mechanism, the positioning surface rotating mechanism and the gripper gripping mechanism from a program library, and combining the target operation methods to obtain a current execution procedure method, wherein the program library prestores a combined method of multiple process surface overturning methods corresponding to the automatic process surface overturning mechanism, multiple positioning surface rotating methods corresponding to the positioning surface rotating mechanism and multiple gripper gripping methods corresponding to the multiple execution motions of components corresponding to the gripper gripping mechanism; and
controlling the components in the automatic process surface overturning mechanism, the positioning surface rotating mechanism and the gripper gripping mechanism to perform an operation on the to-be-machined workpiece according to the current execution procedure method.

8. The method according to claim 7, wherein a fixing support of the gripping mechanism, a rotating mechanism of the gripping mechanism, four grippers of the gripping mechanism, and two telescopic mechanisms of the gripping mechanism; the gripper gripping mechanism is connected with an external movement mechanism through the fixing support of the gripping mechanism; the rotating mechanism of the gripping mechanism is installed at a lower end of the fixing support of the gripping mechanism; the two telescopic mechanisms of the gripping mechanism are respectively: a first telescopic mechanism of the gripping mechanism and a second telescopic mechanism of the gripping mechanism, and are disposed on two fixed surfaces of the rotating mechanism of the gripping mechanism, and the two telescopic mechanisms of the gripping mechanism are perpendicular to each other; the four grippers of the gripping mechanism are respectively: a gripper 1, a gripper 2, a gripper 3 and a gripper 4; and the gripper gripping mechanism (6) is used for gripping and putting the workpiece, transferring the workpiece to the transfer platform under the drive of the movement mechanism, or loading or unloading a material onto or off a device;
the to-be-machined workpiece is a six-sided cube, the program library comprises 6 process surface overturning methods corresponding to the automatic process surface overturning mechanism, 4 positioning surface rotating methods corresponding to the positioning surface rotating mechanism and 8 gripper gripping methods corresponding to the gripper gripping mechanism, wherein the 6 process surface overturning methods comprise: overturning from a right side surface to a top surface, overturning from a left side surface to the top surface, overturning from a lower bottom surface to the top surface, overturning from a front side surface to the top surface, overturning from a rear side surface to the top surface and no overturning of the process surface; and the 4 positioning surface rotating methods comprise: rotation from a right side surface to a rear side surface, rotation from a left side surface to the rear side surface, rotation from a front side surface to the rear side surface and no rotation of the positioning surface; and
there are the following 8 gripper gripping combinations:
workpiece loading of the gripper 1, workpiece unloading of the gripper 2, and workpiece picking of the gripper 1 after overturning;
workpiece loading of the gripper 1, workpiece unloading of the gripper 2, and workpiece picking of the gripper 2 after overturning;
workpiece loading of the gripper 1, workpiece unloading of the gripper 2, and workpiece picking of the gripper 3 after overturning;
workpiece loading of the gripper 1, workpiece unloading of the gripper 3, and workpiece picking of the gripper 2 after overturning;
workpiece loading of the gripper 1, workpiece unloading of the gripper 3, and workpiece picking of the gripper 3 after overturning;
workpiece loading of the gripper 2, workpiece unloading of the gripper 3, and workpiece picking of the gripper 2 after overturning;
workpiece loading of the gripper 2, workpiece unloading of the gripper 3, and workpiece picking of the gripper 3 after overturning; and
workpiece loading of the gripper 3, workpiece unloading of the gripper 4, and workpiece picking of the gripper 3 after overturning.
